(19) United States
(12) Patent Application Publication
(10) Pub. No.: US 2015/0310174 A1
(43) Pub. Date: Oct. 29, 2015

(54) METHOD OF SECURE ACCESS TO CONFIDENTIAL MEDICAL DATA, AND STORAGE MEDIUM FOR SAID METHOD

(71) Applicants: Patrick COUDERT, Roquebrune Cap Martin (FR); Jabir ABDELALI, Marrakech (MA)

(72) Inventors: Patrick COUDERT, Roquebrune Cap Martin (FR); Jabir ABDELALI, Marrakech (MA)

(21) Appl. No.: 14/651,791

(22) PCT Filed: Dec. 13, 2013
(86) PCT No.: PCT/EP2013/003772

§ 371 Date: Jun. 12, 2015

(30) Foreign Application Priority Data
Dec. 13, 2012 (FR) 12/03396
Jan. 31, 2013 (FR) 13/00205
Jun. 21, 2013 (FR) 13/01457

(51) Int. Cl. G06F 19/00; H04L 29/06; G06F 21/46; G06F 21/62; G06F 17/30

(52) U.S. Cl. CPC G06F 19/322; G06F 21/6254; G06F 17/30312; G06F 21/46; H04L 63/083

(57) ABSTRACT

A process for generating a digital medical file stored on a secure server (50) and accessible from a first system (10) via a data communication network, the digital medical file including both nominative data and confidential data, said process further comprising the automatic generation of an Urgency Medical Profile, UMP, devoid of any personal data and devoid of any confidential information, which allows an indirect access to the digital medical file via a trusted third party.

The concept of Medical Profile, which is a particular and temporal mode of the medical file prefigures the transmission of the digital medical information continuously from the patient to his doctor (or vice versa), with the objective of creating an universal and interactive external digital support (USB card, Smartphone, digital tablet, etc. . . . ) affording physical realization to the Patient/doctor relationship for tracking the Personal Digital Medical File.

### TECHNICAL FIELD

The present invention relates to information handling systems, and more particular to a process for secure access to confidential medical data, including consultation of a medical file or emergency medical profile.

### BACKGROUND ART

With the rise of modern transportation techniques, the mobility lies at the very heart of concerns of contemporary individuals belonging to the 21st century. With a resulting need to significantly dematerialize important information relating to them, with is even more critical as those individuals may be very far from their respective homes.

This problem obviously arises for medical information which an individual may gather for constituting his/her medical file or profile. With a need for an on-line access to such file or profile wherever the individual is located and also in any condition where such on-line access is requested.

Different techniques have been elaborated by the applicants of the present application for developing the concept of a digital medical file—be it anonymous or not—which allows one individual—a possible user of a public or private medical service—to fully use his or her digital medical file including his/her own private information.

European patent application No. 08368018.1 dated 19 Sep. 2008 (Publication EP2166484), entitled “Process for access to personal data, such as a personal medical record from a generation of local agent” filed by the Applicants of the present application, describes a first technique for achieving a dematerialized medical file of a user/patient coming to consult a group of therapists. For this purpose specific procedures are implemented to ensure an anonymous storage of the medical file on a so-called DMA Anonymous Medical File, which file is used when a patient comes to consult one practitioner for generating, within the practitioner's office, one instance of the—personalized—patient's Nominative Medical File, while preserving the confidentiality of the sensitive information included within such file. In this way, the patient may consult various practitioners who may or may not belong to a same professional team and may be located at different physical areas. With every practitioner, the patient will safely get an on-line access to the personalized medical file without any risk that some IT service providers involved in the transmission of the information might break the chain of secrecy.

It is thus possible to preserve the confidentiality of information stored on the Internet network. The solution that is described in the aforementioned European patent application thus provides a significant improvement to the service received by the patient who, however, has to remain confined within the premises of the practitioner's office and come to an end when the patient takes leave of his practitioner.

French patent application 11/02726 filed by the Applicants of the present application on Sep. 8, 2011, “A method of accessing and sharing a computer file enriched by customized multimedia resources”, and unpublished at the filing date of the present application, describes an improvement technique which can be used by a patient or an individual for acceding to his personal medical file, enriched with numerous appropriate references and resources which may be selected by the practitioner.

French patent application 12/00907 filed by the Applicants of the present application on Mar. 27, 2012, entitled “A method of accessing and sharing medical records” and unpublished at the filing date of the present application, describes an improvement for facilitating the sharing of a medical file between multiple practitioners belonging or not to a same professional entity or even a same country.

French patent application 12/02401 filed by the Applicants of the present application on Sep. 10, 2012, entitled “Method of access and sharing of medical records” describes a method enabling remote on-line consultation between a patient and his practitioner, while allowing secure access to a shared medical file, nominative or not, which is hosted on a third party server. The remote on-line consultation between the patient and his/her practitioner allows a validation by the latter of the patient's new medical data to be stored within the shared medical file and, therefore, the update of such medical file.

Those patent applications correspond to significant improvements brought to the development of a true digital medical file and which may serve the goals of a modern policy for Public Health development.

However, if the techniques which were evoked above are a first step for allowing the constitution, the update and on-line access to a dematerialized digital medical file for the patients and their practitioners, one problem remains highly critical. This is the problem of one situation of emergency wherein one patient might be faced, without having any access to his/her digital medical file. Indeed, in a situation of shock or unconsciousness, the patient is no longer able to get an on-line access to his/her digital medical file and the data therein included, even though such data was patiently gathered over the years with the hope that it will serve the particular data when the patient's outcome might become critical.

As seen, it is highly critical that a paperless medical file can serve in all foreseeable circumstances, including that of an emergency situation in which the patient is in shock or even unconscious.

Of course, one may imagine that the patient keeps in his wallet codes and access keys to the digital medical file in the hope that these codes and keys can be used in an emergency situation.

But this solution—simple in its application—clearly raises an issue of security since when the wallet is stolen, the owner of a stolen wallet might be exposed to a unlimited disclosure of the personal medical data included within his/her medical file.

This is one of the problems to which the present invention provides a solution.

Another problem is also to be able to perfectly meet the legal requirements relating to the use and abuse of digital information which are applicable in the different countries, and particularly in the countries having the more sophisticated legal rules as those belonging to Convention 108, to which France belongs with its corresponding authority CNIL (Commission Nationale Informatique et Liberté under the French law).

It is therefore highly desirable to secure the information exchanged between a secured and centralized server (providing hosting in every country with an adequate level of protection in accordance with the country's regulation), and an external media, such as card or/and USB key. It is particularly important that the exchange complies with national regulatory requirements existing in most countries, especially in countries whose legislation tends to establish a very high level of legal protection of personal and/or health data.

### SUMMARY OF THE INVENTION

It is an object of the present invention to provide a method for accessing a personal and confidential medical file that can be used in a wide variety of situations, and particularly in emergency situations where a patient becomes unable to access to his file.

It is another object of the present invention to allow everyone to create a Medical Profile to be used in a situation of emergency, (or to put forward specific health issues not specifically related to emergency), through a medical validation performed at several levels (medically relevant questionnaire, medical attachments, secondary validation made by a practitioner . . . ).

It is another object of the present invention to achieve a method for publishing or keep confidential any medical data being recorded by the patient himself within the digital medical file.

It is still another object of the present invention to achieve a method for accessing a registered medical file improving the effectiveness of emergency services which are likely to be involved during a patent's life.

Furthermore, it is an object of the present invention to achieve a new medical card which is capable of storing non nominative and non confidential data of an urgency medical profile, and which allows subsequent access to more sensitive data by means of a secure access process.

More broadly, the process can be applied to a wire range of situations other than the urgency, allowing the patient's relevant medical file to be transported to any practitioner, even when not an emergency doctor.

Those and other objects are achieved by a process for generating a digital medical file stored on a secure server and accessible from a first system via a data communication network, the digital medical file including both personal data and confidential data.

The process further comprises the automatic generation of an Urgency Medical Profile, UMP, devoid of any personal and any confidential information, which can be displayed without the need of any password, and/or which allows an indirect access to the digital medical file comprising personal and medical information through a login/password procedure or, alternatively via a trusted third party.

In one particular embodiment, the Urgency Medical File, UMP, is generated when opening the account holder, following the filling of a predetermined medical questionnaire. Preferably, the entering of data is associated with the assignment of a confidentiality flag representing the confidentiality of each data entered by the holder of the medical file.

In one particular embodiment, the Urgency Medical File, UMP, is stored on a physical media held by the holder, such as a memory card or USB key, allowing unrestricted access to said non-confidential information entered by cardholder. Preferably, the contents of said physical support is protected by electronic signature so as to guaranty the integrity of the data therein stored. In particular, the support comprises a link towards said secure server for the purpose of allowing an access to the personal data and to the confidential data stored on said server via a procedure of checking of login/password.

In one embodiment, the process involves the steps of:
creating an account and generation of an identifier and a password;
creating an administrative questionnaire comprising administrative personal data;
creating a medical question for the purpose of collecting medical data, possibly accompanied by attachments confirming such data;
generating a summary of the data entered via the medical questionnaire, in relation to a classification tool allowing each data to be associated with a confidentiality flag representing confidentiality of the information or not;
designating one or more trusted third parties;
generating automatically an Urgency Medical Profile, UMP, which only comprises non personal data and data deemed non confidential, said Urgency Medical Profile being stored in an unprotected area and may be access from an external support comprising said identifier, the other personal data and/or confidential data being stored within a protected area of said secured server and may be accessed through the identifier and the password;
   said Urgency Medical Profile further comprising a link/mean allowing an access to a trusted third party so as to obtain a substitution key or any other technical means which may be used in the absence of the password.

In one particular embodiment, the creation of the administrative questionnaire further comprises, for one or more data being entered within said administrative questionnaire, an substitution identification function which allows a subsequent access to the medical file without the knowledge of the account's identifier.

In another embodiment, the Urgency Medical Profile, UMP, is stored on an electronic card fitted with a USB port, and assigned to the account holder.

In one particular embodiment, the electronic card is used for storing synchronization data with said secure server.

In another embodiment, the personal data and/or the confidential data can be accessed from the knowledge of the identifier assigned to the account holder together with the corresponding password.

Preferably, the personal data and/or the confidential data can be accessed from the knowledge of the identifier assigned to the account holder together with the substitution key, and further to the authentication of the system requesting access to the personal data and/or the medical data, said authentication evidencing that the system belongs to an emergency service or emergency department (or owned by an emergency doctor).

The invention also achieves a process for accessing a digital medical file stored on a secure server and which can be accessed from a first system via a data communication network, said digital medical file comprising personal data and confidential data.

The process further comprises:
displaying an Urgency Medical Profile, UMP, which is devoid of any personal data or confidential data, and which allows an indirect access to the digital medical file comprising confidential data and/or personal data via a trusted third party;
the access to said digital medical file via one or more trusted third party, each trusted third party having a substitution key or any other technical means for unlocking the medical file. In one particular embodiment, the access to the medical file results from the receipt by the secure server of an electronic mail transmitted by the trusted third party's own system, the electronic mail consisting in the substitution key allowing access to the medical file stored by the secure server.

Preferably, the electronic message emitted by the trusted third part, and which servers as a substitution key, is a SMS or a email, or still a message generated from an application installed on the trusted third party's own system.

Alternatively, the opening of the digital medical file can result from the receipt by said secure server of a vocal call from said trusted third party.

More specifically, the process further comprises the steps:
accessing said secure server manually or automatically, possibly by means of a physical support comprising an identifier;
presentation of the identifier (in the case where the latter has not been automatically transmitted)
opening of a session with the secure server and displaying of the Urgency Medical Profile or UMP,
accessing to the nominative data and/or confidential data by entering a password and, if the password is found valid, opening the medical file;
if no password is submitted or if the submitted password is found invalid, optionally transmitting an email to the account holder for advising the letter of a possible fraudulent request to access the medical file;
in the case of no valid password, execution of a procedure of trusted third party which may allow the opening of the medical file, further comprising:
   identifying of one or several trusted third party(ies);
   contacting one or more trusted third party and obtaining an approval for accessing the medical file (substitution key; or any other technical means)
   validation by said secure server of the approval;
   issuing an authorization by said secure server to the requesting system, either based on a substitution key (after checking of said substitution key and, if case of matching with the keys being registered within the medical file, opening the medical file), either by any other technical means and particularly by the issuance of a random and temporary password automatically generated by the server. The Transmission of such information to the emergency service or to the requesting doctor shall be made by any technical means (email, sms, application installed within a smartphone . . . ) and such authorization allows the emergency service/practitioner to accede the nominative and/or confidential data included in the medical file.

In the case of the use of a substitution key of the trusted third party, such key can, preferably, correspond to the card identifier owned by trusted third party.

In one particular embodiment, the access comprises the following steps:
plugging and reading of a non nominative card comprising an Urgency Medical Profile, UMP, which comprises no personal and no medical information, as well as a link allowing an access to said server as well as to one ore more trusted third parties;
displaying the Urgency Medical Profile on one information handling system;

The invention also allows the realization of a storage support, such as a medical card, comprising electronic circuitry together with storage circuits for the Urgency Medical Profile.

It should be noticed that in order to comply with the anonymous character of this medical card, some additional security requirements can be added:
the card, itself, is intended to contain no nominative information so as to prevent any link between the medical information and the personal information of the card holder.
the contents of such card is firstly intended to remain anonymous and secondly has been validated by the patient as being authorized for being displayed
regarding some possible attachments, the patient is provided with the possibility, when one document is scanned, either to remove the nominative information (by an adhesive stick on the document itself or any other system) so as to allow the displaying of an “anonymous” attachment on the Urgency Medical Profile.
the system will allow to separate the nominative part from the non nominative part and thus incorporate within the summary document the corresponding attachment. Such attachment shall also be accessible when the medical file is opened.
distinctive signs displayed in the UMP will allow an emergency practitioner to confirm the fact that the person he has to take care of is actually the card holder (size, weight, age, color of the eyes, scars, tattoos . . . )
the card will be issued with a regular identification number determined in accordance with an algorithm (a copy in the drawings being shown as an example), and such identification number being protected so as to prevent any undesired disclosure (envelope+opaque packaging . . . )
where the storage system is based on a USB key (or more generally any other digital external support), the integrity of the data stored within said support shall have to be carefully considered.
thus the security process of the system will prevent the storage of any document is such document is not provided by the secure server (checking of the IP address of the secure server, encryption of the storage area or ciphering of the file)
a security protocol is arranged for the purpose of preserving the integrity of the data during the generation of the PDF file and its transfer on the card/USB key. A blocking/encryption of the storage area or of the file will allow to prevent the storage of any document which might not be generated by the secure server. The patient may not be authorize to store any file or document even when generated by his/her own system, if such file/document has not been forwarded through the secure server. Virus protection may be arranged so as to preserve the integrity of data on the external support/USB etc. . . .

Furthermore, the invention also provides a solution to the problem raised by the international travels over different countries having different national legal systems:
only the data included within the card (since those data is, by assumption, non nominative and deemed to be not confidential) can be accessed even from a country which does not provides a high level of protection;
with regard to the nominative data or confidential data for which an on-line access is provided, only the reading of such data will be authorized. The system shall prevent any transfer of data from a country which does not provide a sufficient or equivalent level of protection;
an automatic control is performed by the secure server for the purpose of identifying the Internet Protocol (IP) address (or any other technique such as the identification of the national language used by the web browser), the country requesting the transfer of data and the secure server will be in a position to automatically block or authorize the transfer in one direction or another, in accordance with the level of protection provided by the national country.

The invention achieves those objects by means of a process for generating a digital medical file to be stored on a removable support, such as a storage card, comprising a storage memory and a computer program stored on the support.

The process further involves the steps:
transmitting a request dedicated to an external server so as to obtain a key or an activation code for said computer program, said request allowing a subscription before said server;
receiving said key or said activation code generated by said server;
starting said computer program for the purpose of entering data input by the patient within a medical Questionnaire adapted for collecting personal and medical data, and the storage of said data within a database located within said removable support, each data being entered by said patient being associated with a flag representative of the confidential nature or not of said data being entered within said questionnaire;
generating automatically a Urgency Medical Profile, UMP, corresponding to the patient, for instance in an electronic format which may be displayed in various languages, and which only comprises data having a flag representative of a non confidential nature.

In one particular embodiment, the support comprises a link to said secure server for the purpose of allowing an access to the normative data and the confidential data stored on said server through a password checking procedure.

Preferably, the process further comprises the steps:
creating an account and generating an identifier with a password;
creating an administrative questionnaire comprising personal administrative information;
creating a medical questionnaire dedicated to collect medical information, possibly accompanied by attachments confirming said information;
generating a summary of the data entered through said medical questionnaire, in relation with a classification tool serving for flagging each individual data with a confidential character or not;
designating one or more trusted third parties;
generating automatically an Urgency Medical Profile, UMP, which only comprises non nominative data and data not deemed to be confidential, said Urgency Medical data being stored in a non protected area and may be accessed from an external support comprising said identifier, the other nominative data and/or confidential data being stored in a protected area of said secure server which may be accessed through the knowledge of said identifier with said password;
   wherein said Urgency Medical Profile further comprises a link for acceding a trusted third party for the purpose of obtaining a substitution key which may be used without the need of any password or any technical means allowing the opening of the medical file, including the personal and/or confidential data.

In one particular embodiment the substitution key results from an express of will of said trusted third party for allowing the access to the medical file, or may take the form of an electronic message, such as a SMS or an email, or a vocal call, or an electronic message transmitted by an application on the Trusted third party's system.

The invention also achieves a electronic storage support for storing a digital medical file comprising a storage area for said digital medical file, and a computer program stored on said support. The support further comprises:
means for transmitting a request dedicated to an external server for the purpose of obtaining a key or an activation code of said computer program, said request allowing an administration subscription before said server;
means for receiving the key or said activation code generated by said server;
means for starting said computer program so that the patient may enter data within a medical Questionnaire adapted to collect personal and medical data, and the storage of the latter within a database which is located on said storage support, each data being entered being further flagged as being confidential or not;
means for automatically generating an urgency medical profile corresponding to the patient, for instance in an electronic format which may be displayed in various languages, and which only comprises data being flagged as being non confidential.

In one particular embodiment, the support comprises means for allowing an indirect access through a trusted third party to the digital medical file including nominative and/or confidential information.

Preferably, the support further comprises a link to said secure server allowing an access to the nominative data and confidential data.

Preferably, the support is a storage card or a USB type key.

In one particular embodiment the computer program present on the support is a management application allowing the question to be integrated in the external support (USB or other type). It therefore consists of an “embedded application” which is located on an external support. The latter would comply with the same logic for separation the data of the patients in two categories: firstly the data which may be displayed without limitation, and the more sensitive data which needs to be flagged as being confidential and may be access through a login/password procedure (“secure safe”).

This computer program would thus allow everybody to determine which particular information may be published as such or should be considered as being confidential, and even nominative or not (photograph, identity reference . . . ).

In this particular case, the medical validation can also be performed by the introduction of scanned documents and attachments which can server for confirming the information entered during the filling of the questionnaire (in one particular embodiment, a secondary medical validation with an authentication system may be associated in the case of an medical assistance during the filling of the questionnaire).

In this embodiment, the link with the centralized server allows to initialize the card, to issue the passwords which protect the confidential data, to issue a new password if the card holder forgets his current password and, above all, to provide an essential level of security ensuring the blocking of the opening process of the medical file in case of loss or theft.

A security and protection system may be arranged for the external support so as to allow encryption of the embedded software together with the encryption of the data, and protection against viruses . . . .

This embodiment which is based on a computer program being integrated within the external support, linked with a secure server, presents the advantage of preserving the patient's freedom while complying with the Legislator's spirit regarding the protection of medical data. Everybody is thus in a position to determine which particular data are deemed to be essential with a low level of confidentiality for justifying its inclusion within the urgency medical profile which may be accessed in an emergency situation, while keeping restricted access to the sensitive data showing a higher level of confidentiality for the patient.

The concept of trusted third party would thus be usable for accessing the confidential medical data in case where the patient is unable to allow a direct access to such data.

### DESCRIPTION OF THE DRAWINGS

Other features of one or more embodiments of the invention will appear from the following description of embodiments of the invention, with reference being made to the accompanying drawings.

FIG. 1 illustrates a first embodiment of a process for creating an account and constituting a medical file stored on a secure remote server.

FIG. 2 shows a first embodiment of a process for accessing a medical file.

FIG. 3 illustrates a second embodiment of a process for accessing to a medical file, more secure than the first mode.

FIG. 4 illustrates a general architecture of a system used by an urgency practitioner together with that of a trusted third party involved in an automated procedure for accessing the medical file.

FIG. 5 illustrates a third embodiment of a process allowing the automatic generation of a substitution key managed by the secure remote server.

FIG. 6 illustrates an embodiment of a card allowing the storage of an urgency medical file, in accordance with a fourth embodiment.

FIG. 7 illustrates a fourth embodiment of a process for acceding the Medical File DM, wherein the acquisition of the substitution key is directly managed by the secure remote server.

FIG. 8 illustrates a fifth embodiment of a process for accessing the DM digital file wherein the emergency practitioner's own system directly handles the procedure for acquisition of the substitution key.

FIG. 9 illustrates a sixth embodiment showing the local management of personal medical file on an external medium or storage.

FIG. 10 is an illustrative diagram of the process of FIG. 9.

### DESCRIPTION OF THE PREFERRED EMBODIMENTS

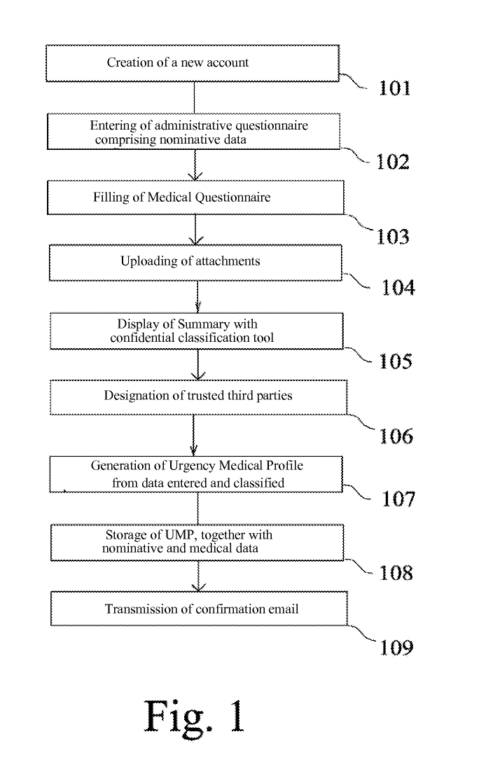

It is now described with reference to FIG. 1, how one can develop the technical elements enabling secure access to digital or computerized medical file stored on a remote secure server, even in a situation of emergency where a patient is unconscious, in shock or simply unable to properly accede to his digital medical file. In such situation, the access is directly performed by an emergency department hospital or a private clinic, and even any doctor's office which is likely to handle such a situation of emergency.

Generally speaking, on considers a digital medical file presented in any form and, more specifically, in the embodiments which will be described hereinafter with details, a set of medical records or data gathered through one particular Medical Questionnaire, specially designed to collect a consistent and classified set of medical data relating to a user or possible patient.

In one embodiment, the access to the medical file comprising nominative and confidential data—which are stored in a protected area of secure remote server—requires a prior generation—and automatic—of a Urgency Medical Profile (UMP) which is generated from the information entered by the patient during the constitution of his/her medical file as described hereinafter, and which functionally serve to provide access through a trusted third party.

### 1. First Embodiment

### The Urgency Medical Profile (PMU) Stored on a Remote Secure Server

In the first embodiment which is described hereinafter, the digital medical file—as well as the Urgency Medical Profile (UMP) which is derived from the latter as described below—are intended to be stored on a secure remote server for the purpose of dematerializing data which can thus follow its owner to suit his travels.

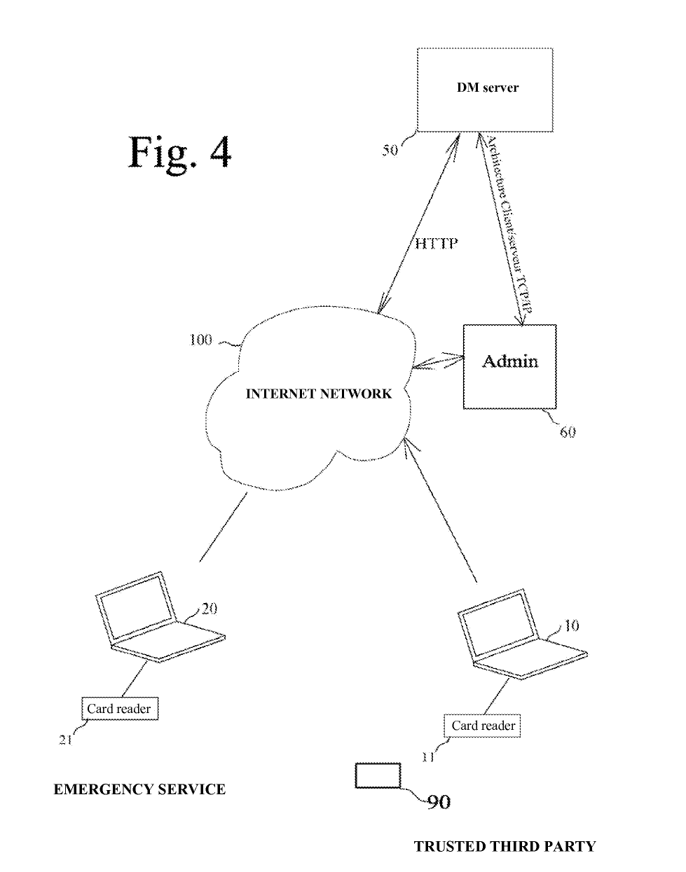

FIG. 1 illustrates more particularly a process to be executed, particularly by the secure server (specifically illustrated by reference 50 in FIG. 4) so as to create a user account and generate the medical file and, then, automatically generate the Urgency Medical Profile (UMP.

In a step 101, an access to the secure server is performed by a user having an access to the Internet network through a Internet Network Service Provider and a new user account is created. Practically, such operation also involves the generation of an identifier ID and a password which can be freely used by the patient in any conventional manner for getting an unrestricted access to his medical file, for acceding the medical records therein included and/or for updating the latter. In general, the identifier ID will be created by the secure remote server, either directly without any preliminary information or secondarily further to the presentation by the patient of another primary identifier, such as that used by banking services (MasterCard, Diners, American Express—all being registered trademarks of their respective owners).

In a particular embodiment, one may consider that the creation of such an account requires a subscription, which can then be materialized by a physical support or media received by the patient, such as a plastic medical card displaying the identifier (but not the password), and intended to remain, with other payment or credits cards etc within the patient's wallet . . . .

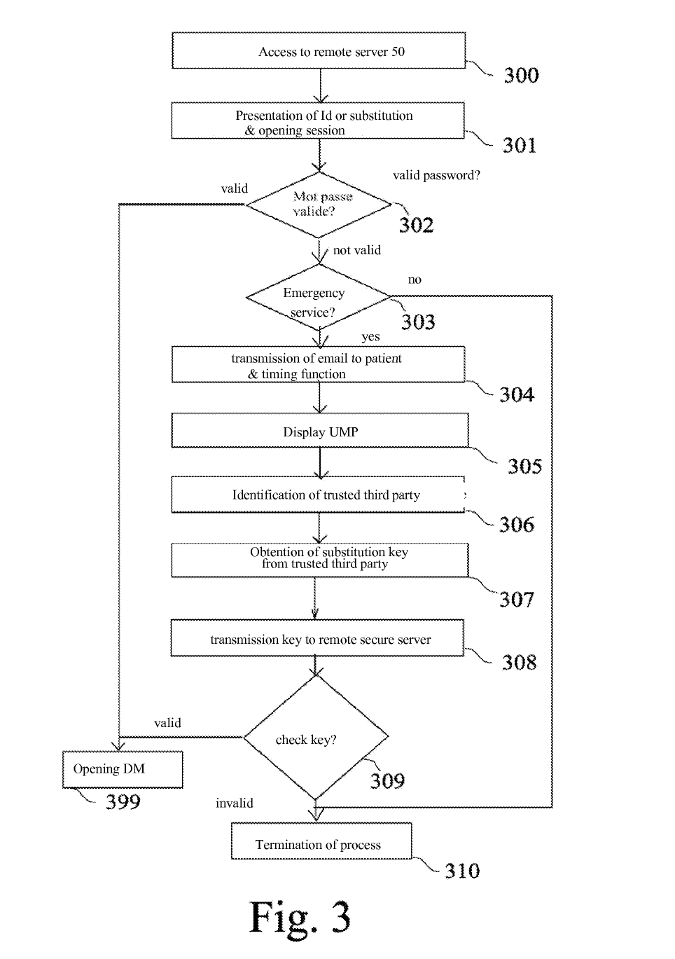

Preferably, the physical support will take the form of a card, similar to a credit/payment card, and which visibly displays the account identifier and a QR code containing Uniform Resource Locator (U.R.L.) address of the remote server. The card will further includes a set of electronic circuits associated with a USB connector, as will be described in reference to FIG. 3. Thus, this physical support will allow three distinct access mode to the secure server.

In a step 102, the server generates a first administrative form or questionnaire dedicated to allow the user to input administrative and personal or nominative data such as, for example: name, date and place of birth, address, telephone number, email address etc. . . .

According to one particular and optional embodiment, the entering of data within the questionnaire is carried out by means of a graphical user interface offering a specific tool allowing the user to assign a partial identification function for the purpose of replacing one or more personal data being inputted, which together collectively will serve for acceding the medical file in a new so-called urgency mode, in accordance with the procedures which are described hereinafter.

Then in a step 103, the process proceeds, thanks to an adequate Graphical User Interface, to the display of a Medical Questionnaire comprising a set of forms or medical sub-questionnaires carefully elaborated and designed for the purpose of collecting a wide number of medical data relating to the patient. The presentation of the Questionnaire may include special descriptive fields for explaining the different questions displayed to the patient and also provide/present special advice in accordance with the data filled within the Questionnaire.

This questionnaire can be filled either by the patient himself or jointly by the patient and his doctor, especially during a consultation, which may be dematerialized consultation as described in the French patent application 12/02401 dated of Sep. 10, 2012 entitled “Method of access and sharing of medical records” and filed by the applicants of the present application, which has the advantage of allowing immediate validation by a professional practitioner of the medical information entered on the secure server. More generally, one may consider the use of the procedures described in the above mentioned patent applications, in particular for the purpose of enriching the medical file being stored on remote server 50.

In the case where the patient/user decides to manage his own medical file, the latter will personally fill the questionnaire submitted to it by the interface of the secure server, waiting for the validation of the latter by a practitioner of his/her choice.
the patient may himself fill information about his health following a detailed questionnaire, which can be displayed and recorded in many languages.
This questionnaire may contain several categories of questions of interest for emergency services, but may also contain more specific questions related to some specific profiles (sport, chronic diseases, disability, autonomy, psyche, dependency . . . )
This questionnaire will provide all sorts of questions (bullets questions, radio buttons, multiple choice, related questions . . . ) with the aim of formulating questions in a most understandable and simple as possible so as to get the most medically accurate and relevant answers from the user.
The synthesis of this questionnaire will aim to present the data and medical information entered by the patient in a priority order useful for emergency services (with a weighting system automatically displaying the answers in an appropriate order required by professional medical practitioners and not in the order entered by the patient).

In one particular embodiment, the Graphical User Interface used for filling the Questionnaire comprises a specific tool for uploading attachments, under the form of any kind of icon to upload electronic files of any formats—including JPG, BITMAP, TIFF, PDF etc.—from the user's personal computer to the remote server, as this is illustrated in a step 104 of FIG. 1.

It should be noted that these attachments which are representative of prescriptions, certificates, analysis reports etc . . . are of great interest since they also allow to confirm a validation subsequently performed by the user's doctor further to the filling of the questionnaire. Those attachments can even be used by an emergency doctor who has to take care of an unconscious patient, in the absence of his usual physician, and who may thus use the attachments for also confirming the medical data recorded within the questionnaire. In that respect, and this is a first advantage of the process being described, the attachments achieve a first significant level of a medical validation of all the data recorded within the questionnaire since those attachments will be, as described below, available to an emergency physician even without any knowledge of the password associated to the identifier of the account, thanks to a substitution procedure which shall be described below. It should be noticed that in one particular embodiment, the attachments can be stored in the same secure server which is intended to store the medical file, or even within a separate server.

When the Medical Questionnaire is completely filled by the user, the process then proceeds to the display of a screen or multiple screens providing a summary, in a step 105, of the different pieces of information constituting the different sub-questionnaires composing the Medical Questionnaire.

In one embodiment, when the different summary screens are displayed to the user by the Graphical User Interface, the latter provides a classification tool allowing the user to assign or not a confidential nature to each individual data included in the Medical Questionnaire by the assignment of a specific field representative of said confidentiality nature. Such functionality is, as we shall see, particularly important since it is intended to entrust to the patient's free will regarding confidential or not to be attributed to each of the pieces of information composing his/her own medical file and, thus, allowing an automatic generation of a specific Urgency Medical Profile (UMP) which may serve as a first link between an emergency physician and the unconscious patient and, consequently, provide an access to his/her whole medical file.

In a particular embodiment, the process completes the validation of the Medical Questionnaire (and therefore all sub-questionnaires composing the latter) after successful completion of the classification made by the patient.
the patient has decided to publish or not each piece of information contained in the summary part (taking into account the fact that Article 8 of the “Loi Informatique & Liberté” applicable in France allows any person to make public the information about it), which shall be recorded within a document available on the secure and certified server.
This document can be saved to the USB port of the card.

Then, in a step 106, the secure server requests that the holder of the newly created account proceeds to the designation of at least one trusted third party, with the input of identifying information such as name, telephone number, email address etc. In a particular embodiment, the account holder is offered the possibility of designating several trusted third party (at least 3). In a particular embodiment, such third party or the different trusted third parties will be associated with a substitution key, for instance on a physical medium or support such as a card, the latter being also recorded within a table stored in an protected area of the patient medical file. In one particular embodiment, the substitution key can simply be identifier assigned to the trusted third party which the latter uses for acceding to its own Medical File.

In another embodiment, the substitution key may be reduced to its simplest expression, and will be replaced by other technical means (email, sms, icon of an application on a smartphone) allowing the third party to express his/her approval regarding the access of the medical file—confidential and/or nominative—by the emergency physician having to take care of the unconscious patient. The access request can be thus validated and automatically results in the generation of a random and temporary password which is transmitted to the server of the physician's computer or to the emergency server requesting the access.

It should be noticed, and this is an important aspect, that the substitution key which has been formally assigned and received by the trusted third party should not be confused with the password that is regularly assigned to the account holder and owner of his medical file. Indeed, one can imagine that the relationship of trust between an account holder and his/her trusted third party is strong enough for having a same password being shared by both persons, with the consequence that each party is given free and unlimited access to the medical file. However, when a trusted third party only receives a substitution key—taking the form of an identification number or any other virtual expression such as a specific data present in a smartphone as described below—such substitution key can not be used for serving a second “parallel” access to the medical file. The substitution key shall only serve within the frame of an emergency procedure as will be described below.

Following the completion of the designation of the trusted third party in step 106, the server then proceeds, in a step 107—and this is a particularly advantageous aspect—to the automatic generation of a Urgency Medical Profile (UMP) comprising critical vital information, although not nominative and not confidential and appropriately presented in order of importance and relevance to the needs of emergency service. Optionally, a graphical interface will allow the implementation of a tool permitting the priority order of the information of the Urgency Medical Profile (PMU) to be changed. Preferably, the UMP will be multi-lingual so that it can be automatically displayed in one predetermined language used by the emergency service. Clearly, this is only one non-limiting example.

In more specific embodiments, the process also allows the generation of other types of medical profiles, fitting more specifically the requirements to certain categories of patients/users, including:
An Disability Medical Profile comprising an abstract including medical data—being not nominative and presumed not confidential by the holder—which is appropriately organized so as to match the requirements of a lifestyle with disabilities;
A Sport-Health Medical Profile comprising an abstract including medical data—being not nominative and presumed not confidential by the holder—which is organized to fit the lifestyle requirements of a high level sportsman;
A Chronicle Medical Profile comprising an abstract including medical data—being not nominative and presumed not confidential by the holder—which is organized to fit the needs of people suffering chronic diseases;
A Baby Medical Profile, child, senior, etc.

These various Medical Profiles, including the Urgency Medical Profile (UMP) are automatically generated by the server, based on information collected during the filling of forms (and subsequently validated by the patient's doctor), but also according to various classifications operated by the account holder.

Thus, if it is built on the foundations of medical data entered by the patient and subsequently validated by a doctor, the Urgency Medical Profile (UMP) is automatically generated by the process in accordance with the patient's will, who may determine which individual piece of information of the Medical File input during step 105 should be assigned a confidential nature.

Therefore, the Urgency Medical Profile (UMP) is fundamentally different from any conventional digital medical file, both in its internal structure and in its function.

First, with regard to its structure, the Urgency Medical Profile (UMP) is a set of data, automatically generated by the process of FIG. 1, which contains only information being NON NOMINATIVE and classified NON CONFIDENTIAL as well as an—non confidential—evocation of confidential information which is likely to be found within the medical file stored in the secure server. Therefore, whereas the medical file is dedicated to continuously grow with the hazards and the medical interventions that punctuate the life of the patient, the Urgency Medical Profile (UMP) is deem to show more stability because it is a summary, an abstract, and collects the most important data—being non nominative and non-confidential—useful for a emergency service which is likely to take care of the patient.

Furthermore, with regard to its function, we will see, with the procedures described below, that the Urgency Medical Profile (UMP) is key, a way for accessing the medical file under an emergency procedure. To achieve this, the UMP allows a direct access to the secure server in order to allow complete opening of the patient's medical file and records, in particular thanks to one among the trusted third parties which were previously designated by the holder of the medical file. In one particular embodiment, the Urgency Medical Profile (UMP) includes an identifier or a non-nominative link for accessing to the trusted third parties designated by the holder.

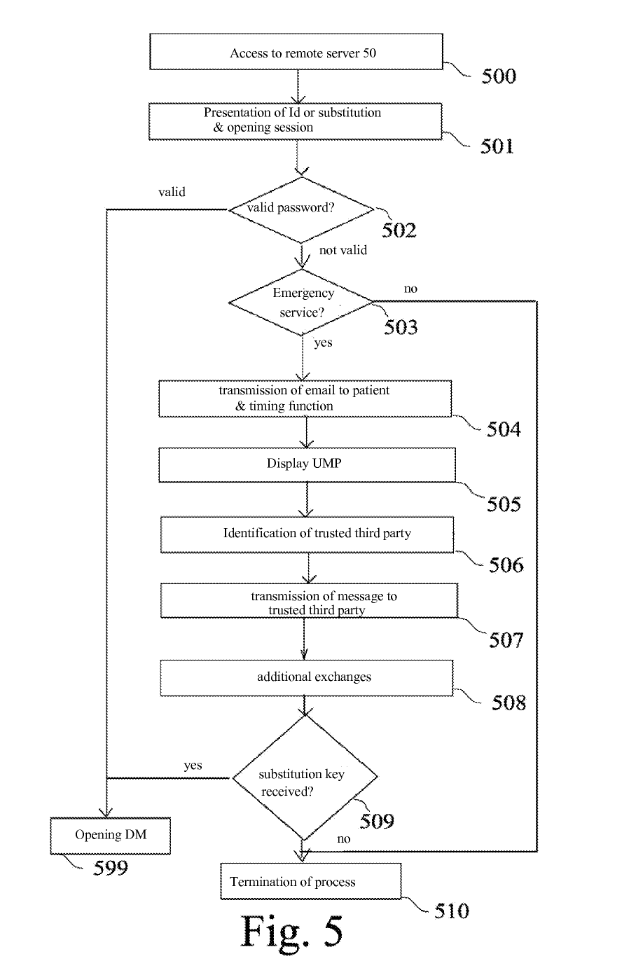

Returning again to the process of FIG. 1, we see that, following the generation of the Urgency Medical Profile (UMP) in step 107, the process proceeds in a step 108, with the storage of the latter, preferably on the secure server (but also on the physical medium in the case of medical card illustrated in FIG. 5), together with the whole set of data, both medical and administrative, which was entered by the account holder, and particularly the substitution keys which were allocated to the possible trusted third parties.

It should be noticed that all the nominative and/or confidential pieces of information are stored within a protected area of the secure server, which is in principle available through on-line access only through the presentation of the account holder's username together with the corresponding password or, alternatively, with a substitution key provided in accordance with the emergency procedures that will be described later.

At the completion of the process of account creation and when the Medical Questionnaire is stored, the secure server transmits in a step 109 a confirmation email to the account holder.

It should be noticed that the account holder, having received the account identifier together with the corresponding password, will obviously be able to access again to his/her account for the purpose of update his/her medical file by recording new data and/or uploading new attachments. He may also modify the designation of the trusted third parties, when necessary, and the updated data will be clearly reflected, when appropriate (particularly with respect to the designation of the trusted third parties) Urgency Medical Profile.

As shown, the process described above results in a fully automatic generation of a Urgency Medical Profile (UMP) which only comprises non nominative data and deemed non confidential (as classified as such) by the account holder—and which will be used to functionally access to the digital medical file.

It is important to notice—and this is a significant advantage of this embodiment—that it is not necessary to submit the password associated with the identifier to be authorized to accede to the Urgency Medical Profile (UMP). Indeed, the UMP shall be available as soon as the holder's identification card number is known, and more generally when one is in possession of the card assigned to the account holder or, again, when a sufficient set of identifiers is presented, which corresponds to the list created by the patient in step 102.

Thus, in a situation of emergency, as described below in detail, an emergency physician who might have to take care of a shocked or unconscious patient, will be able to directly access its Urgency Medical Profile (UMP), simply by seeking the card held in the patient's wall, and use the card number.

In one particular embodiment, the card includes a QR code which allows, thanks to an appropriate QR scanning software, a direct access to the home page of the secure server, and even cause the downloading of PDF file storing the Urgency Medical Profile (UMP). In this way the emergency doctor can immediately be aware of the critical medical data included in the Urgency Medical Profile (UMP), as well as some general distinctive characteristics—such as height, weight, hair color, scars etc.—to consolidate the idea that the card held by the emergency physician actually belongs to the person he has to take care of. The emergency physician can thus immediately obtain, even while the patient is in shock or unconscious and is not able to present his/her identifier with the corresponding password, a first series of information (blood type, allergies etc. . . . ) which can be particularly valuable for treatments and interventions that might have to be considered.

This information can be immediately obtained and this aspect correspond to a decisive advantage of this embodiment. Moreover, as neither the card or the Urgency Medical Profile (UMP) includes any nominative information or information deemed confidential by the cardholder, loss or theft of the card will have no serious consequence.

However, it might be critical for a emergency doctor to get an access to further medical information or records being stored in the medical file and not displayed in the Urgency Medical Profile (UMP), but simply evoked or mentioned in the latter. Or, it may be useful in special circumstances, that the emergency physician goes into a more thorough examination of the full content of medical file, including the more confidential pieces of information, and particularly some attachments therein included which are likely to confirm or validate one particular statement shown in the UMP, in order to confirm a diagnosis or refine the relevance of treatment envisaged.

Obviously, the emergency physician wishing to access such nominative and/or confidential information, or simply the attachments of the medical files, will be required by the secure server 50 to present, in addition to the ID already presented, the password corresponding to account holder that, in general, he/she does not possess. To meet this critical need, the process that we will now be described taking place, in combination with the concept of Urgency Medical Profile (UMP), arranges a mechanism based on a trusted third party for the purpose of obtaining a substitution key which may serve, as part of an emergency procedure, to access the complete medical file of the patient, particularly including all nominative data and/or confidential data therein included.

To this end, an access link to at least a trust third party is stored within the Urgency Medical Profile (UMP), so as to allow the emergency physician to obtain a substitution key. In one particular straight embodiment, the access link will take on the form of a telephone number listed in the UMP, which the emergency doctor may use for the purpose of calling the trusted third party and thus obtain a substitution key which will be recognized by the secure server as an alternative to the missing password and an authorization to access the medical file.

Alternatively, as will be described later, the own reaction of the trusted third party, ie the manifestation of will that may take various forms (sending an SMS, an email, a call to a server call etc. . . . ) which will constitute the substitution key used in the procedure for accessing the medical file stored in the secure server.

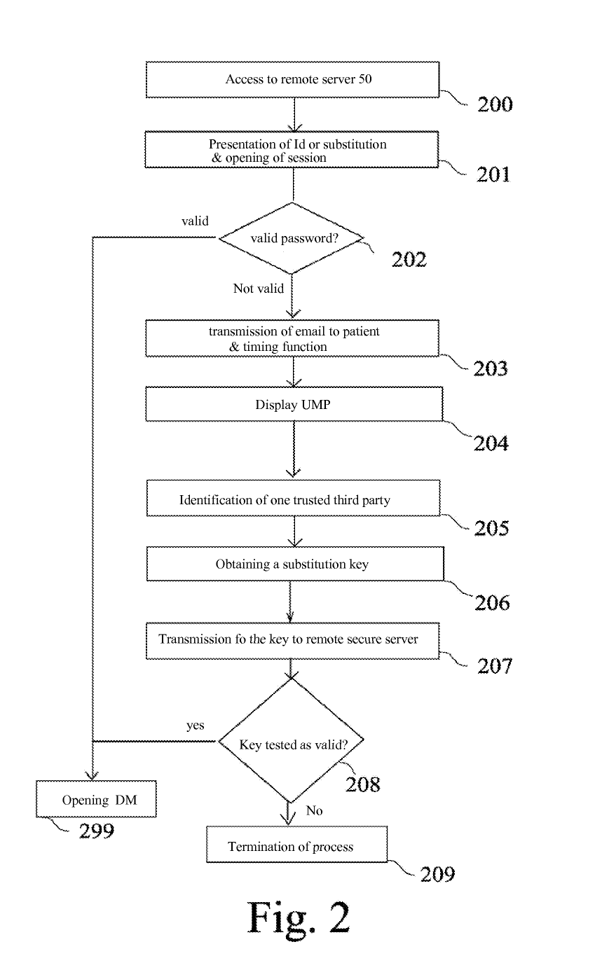

FIG. 2 illustrates more specifically the process steps for accessing, firstly, the Urgency Medical Profile (UMP) stored on the remote secure server 50, and secondly, access the nominative and confidential data included in the medical file.

One considers a situation where an emergency doctor is requested to take care a patient in shock or even inanimate. The doctor only holds the physical support, confirming that patient is likely to hold a medical file, and particularly a Urgency Medical Profile stored on a secure server. In a step 200, an access is performed by the emergency doctor, through the media held, at a secure remote access to the server 50 (shown in FIG. 4).

Practically, this access to the secure server can take various forms. Firstly, the access to the server can be performed via a web browser using the conventional general address. Secondly, an access can also be performed through the scanning of the QR code displayed on the patient's medical card, and including the Uniform Resource Locator of the server. Finally, and this is a third possibility, the emergency physician can directly access the remote secure server by plugging in his/her own computer the USB connector of the card illustrated in FIG. 5, what will automatically result in access to the secure server.

Then, in a step 201, the process proceeds with the opening of a session between the doctor's own information handling system (represented by device 20 in FIG. 4) and the remote server DM, further to the presentation of the identifier of the account displayed on the patient's medical card.

Alternatively, and this is a possible option, the secure server may accept, in place and instead of the identifier assigned to the account regularly—and posted on the medical card—a set of alternative identifiers as defined in filling Administrative form step 102. In this way, when the patient does not hold in his/her wallet the medical card displaying the required identifier, the emergency physician may seek, once it gets enough nominative information regarding the patient, to get a substitution access to the secure server. This will be the case for example when alternative nominative information can be known to the emergency doctor, such as a national identity card, a passport, a driving license etc., all of which allowing the emergency doctor to fill the appropriate fields of the electronic form with nominative data corresponding as possible substitution identifiers . . . which may result in an authorization of a session with secure server 50.

In general, the opening of a session is well known to a skilled person and can be performed via any web browser, such as INTERNET EXPLORER marketed by company MICROSOFT Corp., thanks to the use of secure HTTPS requests (Hyper Text Transport Protocol). For the sake of concision, it is clearly not necessary to further details the procedures to be implemented for this purpose.

It should be noted however, that when establishing the session which opens at the initiative of the doctor's own system 20, various checking procedures might be opportunely implemented by secure server 50, particularly for checking and/our recording the IP address etc. . . . , so as to allow traceability and facilitate the establishment of a file for the possible situation of a criminal complaint; should a abuse or fraud occurs. More generally still, we may consider that emergency doctor's system 20 can be subject of a strong authentication procedure with secure server 50, including through prior registration of systems parameters (such as hard drive serial number, presence of certain peripheral devices, a CPS card if available etc.), which can advantageously allow a systematic referencing by secure server and ultimately an increased authentication and security access of the patient's medical file.

In a step 202, the secure server checks for a password or validity of a password being entered.

In the event that such a valid password is being presented—which corresponds for example to the regular situation of a patient that can communicate with the emergency physician and transmit to the latter his own password opening the access to his/her medical file—then the process proceeds to a step 299 allowing the opening of the full content of the medical file DM, ie including personal and nominative data but also confidential information.

On the contrary, if no valid password is presented, the process proceeds with an optional step 203, with the sending by secure server 50 of a email and/or SMS message to the cardholder, optionally with a set of information collected during the verification performed in step 201, then implement a predetermined timing function, for example 5 or 10 minutes. This step 202 achieves a more secure access to digital medical file to the extent that, in the case of fraudulent access, the card holder will be able, during the timeout period offered, to react and block the opening of his/her medical file.

It should be noticed, in this regard, that during the registration of the patient and the creation of his/her account, the latter can be invited in one embodiment to download from the secure server an application to be installed on his/her computer, tablet and even his/her smartphone, so as to enable the management of messages that can be received from the secure server. Alternatively, the message of step 203 may take the form of an SMS message or an email including the URL link allowing the patient to directly block the requested access to his/her digital medical file.

Then, in a step 204, the process proceeds of Urgency Medical Profile (UMP) stored on the remote server (50) on the display to the display of system 20 of the emergency doctor.

In one particular embodiment, the checking step of the IP address which is carried out by the secure server results in the displaying of the Urgency Medical Profile (UMP) with the appropriate language corresponding to the national language of the country associated to the IP address listed, so as to facilitate the reading of the UMP profile if the patient is traveling in a foreign country and has to be handled by an emergency service located in that country.

In a step 205, the process attempts an identification of a trusted third party in order to obtain a identifier that can be accepted by the secure server. From the simplest way, this can be achieved by displaying the mobile telephone number of one or several trusted third parties, so as to allow the receipt, in a step 206, of a substitution key which may replace the unavailable password.

Then, in a step 207, system 20 used by the emergency physician transmits to the secure server the substitution key received from the trusted third party.

In a step 208, the remote secure server 50 performs a verification of the substitution key.

If the substitution key is recognized by server 50 as a valid one, then the latter authorizes the opening of the medical file in a step 299.

On the contrary, if the substitution key is not recognized to be a valid one, then the process stops in a step 209 without displaying the nominative and/or confidential information—including the attachments—of the medical file. In a complementary manner, a summary message can be sent by email to the card holder to summarize the sequence of messages which were exchanged.

In another simplified embodiment, one may arranged that the trusted third party (who might have lost/forgotten the required substitution key) can use any other technical means (sms, email, smartphone application or other) to transmit to the secure server a specific information that could to be recognized by the latter as “substitution key” which may server for authorizing the accession to the nominative and/or confidential file.

Even more directly, one may consider in a very general way, any expression of will of one or more trusted third parties for constituting a valid substitution key which may be used in the procedures described hereinafter. Preferably, this expression of will may take the form of an SMS (in response to an SMS sent by the secure server), an email (in response to an email sent by the secure server) for the purpose of formalizing the trusted third party's agreement to open the patient's medical file. In a particular embodiment, one can arrange the substitution key to take the form of a voice call transmitted from the trusted third party's mobile phone, which phone call shall be recorded for the purpose to trace the different events having resulted in the opening of the medical file.

In one specific embodiment, the expression of will could be secured by the use of a specific application on a mobile phone owned by the trusted third party, and enabling secure management (would be more secure than sending a SMS) of an authorization transmitted to the remote server.

It should be noticed that any validation/authorization confirmed by a trusted third party will result in the opening in the doctor's system of the medical file comprising confidential and/or nominative data.

The opening of the medical file can be automated if the respective servers remained open and connected, or if they have the capacity to match by software/executable connected and respective links.

Otherwise, this validation will automatically triggers within the secure server the transmission to the practitioner's computer of a random and temporary password.

### 2. Second Embodiment

### Restricted Access with Authentication of the Emergency Service

The first embodiment described above shows how one, thanks to the displaying of the Urgency Medical Profile (UMP), combined with the getting of a substitution key held by a trusted third party or alternatively any expression of will of the latter, to achieve an access to a medical file of the holder, even though there is no password available associated with the account identifier.

Therefore, it follows that, theoretically, the trusted third party may have to frequently consult the medical record of the holder, even though it does not explicitly holds the password, which can be undesirable.

This situation may create a security hole that can be harmful and the process of FIG. 3 illustrates a second embodiment, more sophisticated, to avoid this drawback. Indeed, in this second embodiment, the substitution key held by the trusted third party or any expression of will of the latter can not be used for getting a direct access to the medical file, but can be used only in the case of a real Emergency procedure verified by the secure server.

Steps 300-301 and 302 are identical to steps 200-201-202 in FIG. 2.

In a step 300, the process performs an access to secure server 50.

In a step 301, the process requests the presentation of the account identifier (number displayed on the medical card) or, by default, some substitution identifications elements which were previously defined by the account holder in step 102, thus allowing the session.

In step 302, the process checks whether a valid password is present and, if so, allows the opening of the medical file in a step 399.

On the contrary, if no valid password is presented, the process then proceeds to a test 303 to check whether an emergency situation occurs. In a particular embodiment, this check involves the retrieval of the IP address of the system 20, as well as the retrieval of a series of various pieces of information which are likely to confirm that the access request is made under an emergency procedure. In particular, one may consider a procedure for registration with the secure server of the emergency department or physician's verification of the Health Professional Card (CPS) in order to validate the checking step 303. Alternatively, one may also arrange a systematic referencing of all systems used in emergency services which might frequently request an access to secure server 50, in particular by proceeding with a systematic registration of the hardware elements included into those systems.

In general, any system achieving strong authentication can be very appropriately used.

If the test of step 303 is not successful, then the process immediately proceeds with an ending step 310 terminating the procedure for access the medical file without displaying the latter. Optionally, the method can transmit a summary message to the account holder for advising him/her that a request for access to the medical file was denied.

If, however, the test of step 304 is successful, then the process proceeds to steps 304-310 which are respectively identical to steps 203-209 of FIG. 2.

In particular:

In an optional step 304, the process proceeds to the transmission from secure server 50 of an email and/or a SMS message to the cardholder, possibly with a number of information collected during the investigations and checking procedures of steps 301 and 303, and then implements a predefined timer function.

Then, in a step 305 the process proceeds to the display, on system 20 owned by the emergency doctor, of the Urgency Medical Profile (UMP) stored on remote server (50), possibly in the home language of the service emergency.

In a step 306, the process attempts an identification of a trusted third party in order to obtain an identification information which can be accepted by the secure server.

In a step 307, the substitution key is recovered and ultimately presented to secure server in a step 308.

In a step 309, remote secure server 50 proceeds to the checking of the substitution key and, if the checking succeeds, server 50 authorizes the opening of the medical file, in a step 399.

As before, we can also consider as a substitution key any formal expression of will provided by one of the trusted third party, including the sending of an SMS (in response to an SMS sent by the secure server), the transmission of an email (in response to an email sent by the secure server) or a voice call, etc.

The procedures which were described above, present a significant advantage in that a high degree of automation is achieved which allow to consider new and powerful facilities for acceding to the patients' dematerialized medical files.

Indeed, it should be noted that in the situation which is to be considered, time is vital and the trusted third party is by no means a professional capable of acting calmly in a crisis situation. When the day came, it will intervene with sensitivity—and weaknesses—to supply the password default due to the shock of the card holder. Thus, the trusted third party might also find himself in a major shock and thus it is highly critical to arrange a very secure system for access to the medical file of the cardholder, and particularly by preventing mistakes in the identification numbers etc.

This is the purpose of the three embodiments that will be described now that allows significant automation of the access procedure, so as to avoid the errors which might be fatal for the holder of the medical file, while establishing a wide traceability of the events and exchanges—under the management of the secure server—so as to be able to come back later and as necessary, one the details of the events and steps that granted the access.

The three additional embodiments that will be described now, and that focus on more sophisticated and more automated forms of communication allow to obtain a valid substitution key. This can be achieved with a procedure centralized around the remote secure server (3^{rd} embodiment) or directly by the information system or computer of the emergency service (5^{th} embodiment).

A fourth embodiment will also be described, showing the use of a sophisticated physical support, taking the form of a medical card fillted with its own electronic circuit, for the purpose of storing the Urgency Medical Profile (UMP).

### 3. Third Embodiment

### Automatic Procedures for Obtaining the Substitution Key Centralized by the Remote Secure Server

To illustrate this third embodiment, reference is made specifically to the diagram in FIG. 4, which shows the access to the remote secure server 50 via an intranet or the Internet network, which will centralize all of the procedure for obtaining the substitution key allowing access to the nominative and confidential medical file.

The emergency service is fitted with a information handling system, illustrated in FIG. 20 under the form of a laptop computer, having an access to the Internet 100 and through it to the remote secure server DM 50.

System 20 arranged within the emergency service is also associated with an authentication device, of the type card reader 21, which may serve for various purposes, including for the connection of an authentication card ensuring authentication of the requests transmitted by system 20. One could for example consider a card reader for reading a professional card dedicated to medical practitioners (CPS) which is in use in France, ou any strong based on the use of a smart card . . . . Alternatively, one may also consider the use for the practitioner of an authentication system based on a USB key owned by the latter, or any autonomous system such as a smartphone fitted with authentication means, e.g. electronic signatures, encryption keys.

It is also considered one trusted third party who has, on its side, its own information processing system 10, represented for example by a laptop accessing the Internet network 100 and its own card reader 11. Alternatively, one system of the type mobile smartphone, a Portable Document Assistant, a tablet etc. . . . may also be considered, fitted with their own access means for accessing the Internet network.

It has been shown in FIG. 4, for purposes of illustration, an optional administrative server 60 which is responsible for the administration and management of medical files, and particularly including the administration of subscriptions and the billing.

Systems 10 and 20 are also assumed to be provided with communication means, for instance for transmitting emails, and a web browser such as Internet Explorer of company MICROSOFT Corp. for example, providing a simple and effective access to server DM 50 via the HTTP standard protocol (Hyper Text Transfer Protocol). Such means are well known to those skilled in the art and do not require additional development. One may also consider using specific software and programs for the implementation of notifications and procedures described below. Furthermore, it may also be envisaged that the notifications transmitted via one of the systems 10 or 20, result from a notification transmitted via an external server.

FIG. 5 more specifically illustrates the steps of the process achieving automation of the access to the nominative and confidential contents of the medical file, thanks to a centralized procedure executed at the level of remote secure server DM 50.

In general, steps 500-503 shown in FIG. 5 are similar to steps 300-303 of FIG. 3.

Thus, in a step 500, system 20 of the emergency physician performs a direct access to secure server 50, particularly by means of the web browser installed within the operating system.

Then, in a step 501 the process proceeds to the presentation of the account identifier or alternatively of a series of substitution identifier defined by the holder in step 120, for the purpose of opening a session between system 20 and secure server 50.

Then, in a step 502, the process tests for the presence of a valid password that the emergency doctor might have received, for instance, directly from the account holder himself. If the password is recognized as valid, then the process continues with a step 599 which leads to an access of the full contents of the medical file which can thus be downloaded.

On the contrary, if the password is not found to be valid, the process continues with a step 503 which corresponds to a test for determining whether the request is part of an emergency procedure. In this respect, as before, it may be particularly appropriate to arrange, for the purpose of strengthening the authentication of system 20, various procedures for achieving a strong authentication of system 20, as well as the traceability of exchanges between the latter and the server. One can thus advantageously use prior registration procedures, electronic signature processes as well as strong authentication procedures based on the recognition of particular hardware features of the system.

Then, in an optional step 504, the process proceeds to the transmission of a message to the account holder, with a certain number of pieces of information collected during the verifications performed in steps 501 and 503 (IP address, authentication etc.) and to initialize a counter for the implementation of the timer function that gives an opportunity for the account's holder to block access to his/her account.

Then, in a step 505, the process proceeds to the display on the doctor's system 20 of the Urgency Medical Profile (PMU) stored on the remote server (50). As before, one may arrange the opening of the PDF file directly in an language corresponding to the national language in practice in the emergency service.

Then, in a step 506, the process proceeds to the identification of a first trusted third party previously stored within a protected confidential area. Since the identification of the trusted third party is stored in the protected area of the server, such identification can thus be much richer and more varied than the identification simply formalized by the presence of an “anonymous” phone number displayed in the Urgency Medical Profile (UMP) and which might be exposed to abuses.

Then, in a step 507, the secure server automatically transmits a request to the trusted third part designated in the list stored in the medical file, which transmission may take various forms. Preferably, the request will take the form of an email sent to the address of the trusted third party, possibly coupled with a SMS type message to the mobile phone of the same.

In general, any electronic form of transmission may be considered.

In one particular embodiment, the trusted third party, who previously registered with with the secure server (50)—and this particularly since he also received his own medical card—has an application on his smartphone or his tablet which allows the display of a particular explicit emergency interface.

In particular, the interface allows the trusted third party to look into the identity of the particular emergency service requesting access to the patient's medical file, possibly documented with various factual information regarding the latter (IP address, name of the emergency physician, identification of the Health Professional Card, location of the emergency service), as well as telephone numbers of the emergency doctor requesting the access to the confidential medical file.

In one particular embodiment, one arrange, in a step 508. a possibility of further exchanges between the trusted third party and the system 20, preferably via the secure server 50. In particular, a graphical interface of the application installed in the system 10 of the trusted third party may be arranged with the possibility to transmit—thanks to an appropriate button or icon clearly identified—a photograph of the account holder, which can be, if necessary, sent to emergency physician via the secure server 50 to allow it to confirm, if any, that his patient is really the holder of the medical file for which access is requested.

One can clearly consider any further exchange between system 20 and system 10, as centralized as necessary by the server 50. Generally speaking, it may be useful that the secure server acts as an intermediary during such exchanges so as to allow the traceability of messages exchanged and, consequently, enhance security and prevent abuses and frauds.

After this exchange, the trusted third party is able to decide, thanks to one particular set of icons/buttons very explicitly displayed on the display of his mobile phone (for example), whether the access to the confidential medical file stored in server 50 should be granted, what results in the transmission of a message to server 50 comprising the substitution key provided by the trusted third party.

In a step 509, server 50 tests for the presence of the substitution key received from the trusted third party and if the latter is present, the process continues with a step 599 which is the opening of the confidential medical file.

On the contrary, if the substitution key is not received, server 50 proceeds, in a step 510, to the termination of the access procedure to the medical file, without allowing its opening.

As before, the substitution key may be implicit with the transmission of an authorization message transmitted by the trusted third party, so that such message will be decoded by the remote server as a explicit expression of will formalizing key substitution valid for access to medical records stored on the secure server.

In general, as already evoked, it is of great interest that server 50 keeps track of all access attempts to the medical file, as well as the exchange of messages and requests that occurred so may constitute a folder of evidence for the possible case of proven fraud. In particular, step 510 may be completed by sending a full summary document to the holder's medical record in order to fully inform the circumstances of time and place of the attempted access to his medical file.

### 4. Fourth Embodiment

### The Urgency Medical Profile (PMU) Stored on the Patient's Medical Card

It is now described a specific embodiment based on the use of a sophisticated physical support, taking the form of a medical card fitted with electronic circuitry for the purpose of a direct storage the Urgency Medical Profile (UMP.

Such a card, represented by reference 90 in FIG. 3, can be used for the storage of Urgency Medical Profile (UMP) of the card holder and can also include programs and data required for storing the substitution key serving for the procedures described in this patent application achieving a secure access.

Incidentally, and this is an important advantage of this fourth embodiment, the storage memory present on the medical card can conveniently be used to store other types of Medical Profiles, as mentioned above, namely:
A Handicap Medical Profile, intended for persons with disabilities;
A Sport Medical Profile for sportsmen;
A Chronicle Medical Profile for patients suffering chronic diseases;
A “Baby” Medical Profile, children, seniors . . . for children etc.

Furthermore, the electronic circuits present on the card can opportunely be used for synchronization procedures with the secure server 50. Indeed, further to some consultations and/or examinations carried by the patient, the results of these consultations may be temporarily and advantageously stored within the memory of the medical card, prior to an uploading procedure on the secure website 50.

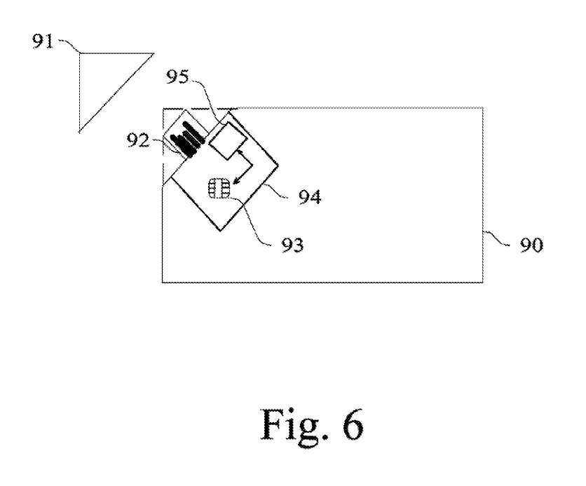

Preferably, as illustrated in FIG. 6, the medical card takes the form of a smart card 90 having a form factor ID-1 which size is 85.60×53.98 mm, and having a chip 93 incorporated according to IS07816 standards including secure identification data. Moreover, the medical card includes a USB port 92 for serial communication with the computer 10 of the patient, and storage means 95 for storing an executable code for implementing the functionality described below, including secure access to the DM server 50. Generally speaking, the active electronic circuits of card 90 may be arranged in a surface 94 incorporating various electronic components, including the chip 93 embedded in the constituent material of the card. A cap 91 located in a corner of the card 90 is used for covering the USB port when the latter is not used.

In a preferred embodiment, the medical card has a USB connector for direct connection to a USB port of a host computer, without requiring any further card reader. This system has the advantage of corresponding to the most common connection method.

In order to avoid fraudulent alterations of the contents of the medical card, all files stored on the card will be appropriately signed by the signature of the secure server (eg the private key of the latter), and thus ensuring integrity of data stored on the card.

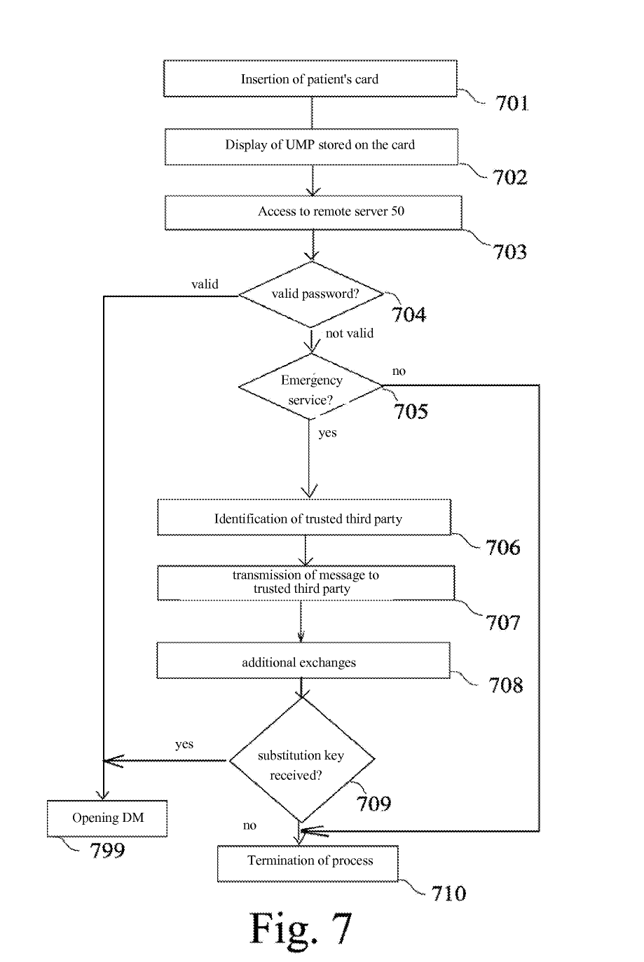

It is now described in relation to FIG. 7, a process for accessing a medical file according to a fourth embodiment.

In a step 701 the process starts with the plugging and the detection of patient medical card 90 into the reader 21 of the system 20 of the emergency physician. This detection of the card causes the execution of computer program being stored on the card which results in an immediate opening of the patient's Urgency Medical Profile (UMP), in a step 702.

Then, in a step 703, upon request from the emergency doctor, the process proceeds to a secure access to the remote server 50. It should be noticed that in this fourth embodiment, the medical card will contain all relevant information enabling automatic access to the server from a specific interface, without the emergency physician has to enter the specific URL (Uniform Resource Locator).

Then, in a step 704, the secure server checks for a password or the validity of a password entered and, in the case of a valid password, the remote server causes, in a step 799, the opening of the complete medical file, resulting in the display of nominative data as well as confidential medical information.

Otherwise, the process proceeds to a step 705 where the reality of an emergency procedure is checked, particularly by testing the authenticity of system 20 requesting access to the medical file. As before, techniques achieving strong authentication may be used, including a technique using the Health Professional Card of the professional practitioner, the identification of the system requesting access (with the assumption of a previous registration procedure of the practitioner's system) or even through the identification of the hardware components of system 20 requesting access to the medical file.

If step 705 fails, then the process goes directly to step 710 corresponding to the end of the access procedure, after which, in a particular embodiment, an reporting email is sent to the card holder.

If the test of step 705 is successful, then the process proceeds to a step 706 wherein remote secure server 50 performs the identification of a first trusted party, which reference was previously stored within the protected confidential area of the card.

Then, in a step 707, the secure server automatically sends a request to the designated trusted third party, which may again take the form of a transmitted e-mail, possibly in addition to a Short Message Service (SMS) forwarded to the mobile phone of that Trusted third party.

As before, a specific previously application can be advantageously installed on the third party's mobile phone or smartphone.

Alternatively, and this is an advantage of this fourth embodiment, it will be sufficient to trusted third parties to perform the insertion of their own medical card in the card reader of an accessible system so as to find the appropriate code and information for completing the authorization procedure and particularly the transmission of the substitution key to secure server 50.

As before, the computer program and code that is stored on the trusted third party's medical card, or the application residing in its intelligent mobile phone can store and record information received from server 50, and particularly the information regarding the identification of the emergency department requesting access to the patient's medical file and all relevant information so as to enable the trusted third party to take a position with regard the access request.

As before, one may consider, in a step 708 a possibility of further exchanges between the two systems 10 and 20, in particular via secure server 50, which exchanges can be stored on the latter—but also on physical media 90 so as to allow traceability.

After this exchange of messages, the trusted third party is, as before, in a position for determining whether or not to accept the request for access to the confidential medical file, and by transmitting the substitution key required by secure server 50.

In a step 709, server 50 checks the presence of a valid substitution key received from the trusted third party and in such case, the process continues with a step 799 which grants the opening of the confidential medical file.

On the contrary, if the substitution key is not received or not valid, server 50 proceeds, in a step 710, at the termination of the access procedure of the confidential medical file without allowing its opening, and also notifying the card holder of the attempt to access the medical file.

As before, one may also consider as a substitution key any valid expression of will formalized by one of the trusted third party, including the sending of an SMS (in response to an SMS sent by the secure server), an email (in response to an email sent by the secure server) or a voice call, etc. In general, it is an object of such substitution key to validate and formalize the Trusted third party's approval received by the secure server, which approval will result in the opening of the confidential Medical File, either in an automated way, or by the transmission to the remote server of a random and temporary password, a SMS, an email etc. . . . In this case, the test of step 709 will succeed with the receipt of a SMS, an email etc. . . . by remote server in response to the message of step 707.

### 5. Fifth Embodiment

### The Procedure for Obtaining a Substitution Key Directly Managed by the System Requesting an Access to the Medical File

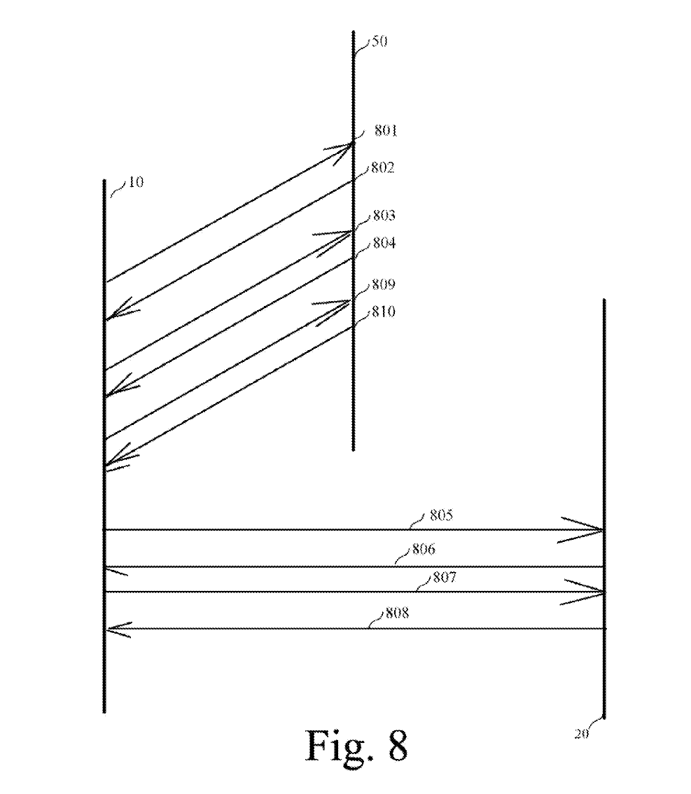

For the purpose of illustrating the high number of embodiments which can be considered, in the wide diversity of their combinations, there will now be described in connection with FIG. 8 a fifth embodiment wherein one can obtain the substitution thanks to a process which is directly managed by system 20 of emergency physician.

In general, the process complies with the procedure that was described above in relation to FIG. 7, with the exception that steps 705-707 are directly carried out between the two systems 20 and 10.

This has the effect of reducing the amount of messages exchanged with the secure server, as can be seen in FIG. 8 showing:

801-802 Posts: corresponds to the access request to the secure server and its response to the latter: Messages 803-804: is the password verification procedure (hypothetically unsuccessfully)

Message 805: request transmitted by the system 20 to system 10 to request the substitution key.

Messages 806-807: show a complementary exchange between systems 10 and 20;

Message 808: corresponds to the transmission by system 10 of the substitution key;

Message 809: system 20 can transmit the substitution key to the secure server and in response (Message 810), gets an access to the medical file of the holder.

As seen, the invention allows for multiple possibilities for the combination of the Urgency Medical Profile (UMP) and the involvement of a trusted third party.

It should be noted that the procedures described above may be conducted sequentially (or in parallel to reduce the processing time) for the whole list of trusted third parties mentioned in the medical file, and thus until the list is exhausted. A skilled person can therefore easily adapt the procedures which were described so as to carry out processing loops for processing the whole list of trusted third parties, until the list is exhausted.

In a particular embodiment, in case of exhaustion of the list of trusted third party, one can arrange the possibility to replace the trusted third party by a trusted organization which may, as a last resort and in particularly serious cases where life-threatening holder is engaged, cause the opening of his/her medical file.

### 6. Sixth Embodiment

### Local Handling of the UMP on an External Support Card (Card/USB Drive or Other Media) Through an Embedded Application

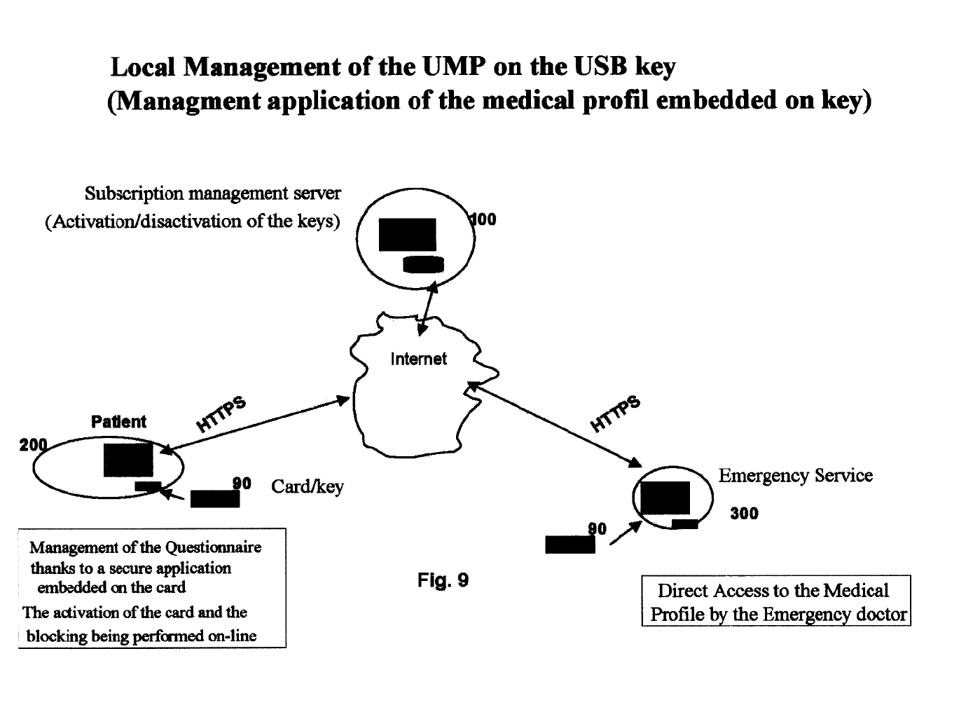

To illustrate other possible embodiments which can be considered based on a simplified and local embedded application present on a card/USB, it will now be described in relation to FIG. 9, a sixth embodiment in which the display of the medical questionnaire is performed thanks to a an embedded software directly located onto the external media.

FIG. 9 more particularly illustrates the process being carried out for the purpose of generating locally the personal medical file thanks to an integrated application which is protectively located on the card (90) and, subsequently, which automatically generate the personal Medical Profile of the card holder. In this embodiment no medical data is stored on the server. Only a card activation key is generated by the server (100) handling the subscription of the patients.

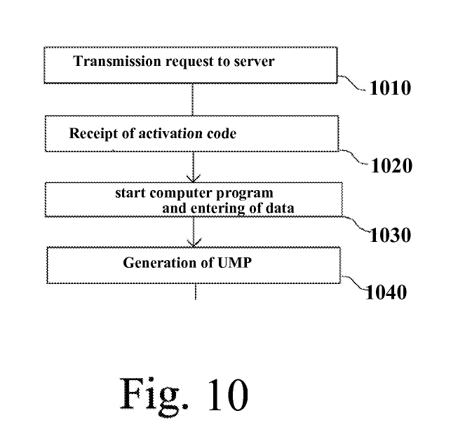

The method is more particularly described in FIG. 10. In a first step 1010, the patient (200), when he plugs the card for the first time into his system, generates an on-line request for activation of the card (90) submitted to the server (100). To achieve this, the process proceeds to the transmission of a request dedicated to the external server, which server allows him to fulfill his personal file (Name, . . . ), then generates a key or an activation code for the card that is transmitted to the card holder through secure communication means (SMS, Mail, . . . ), and which is received in a step 1020.

When he/she inserts his/her card, the patient (200) proceeds with the automatic execution, in a step 1030, of an embedded application allowing the letter to input and record his data. Thanks to the latter, and by entering the login and the password, the patient fills in a Medical Questionnaire designed to enable the collection of personal medical data, each data being entering being associated with a specific flag representative of the confidential nature or not presumed by the card holder. This information is automatically stored in a local database saved on said card (90). A personal medical profile is then automatically generated and saved on the card (in PDF format and in multiple languages).

Thus, in an emergency situation, for example, an emergency doctor (300) who will have to take care of the patient, presumed unconscious or in shock, will be able to directly access the Urgency Medical Profile (UMP) simply by holding the patient's card and inserting the latter into his own system, thus opening the medical profile document. This achieves the displaying—which does not require the knowledge of the password—of information presumed non confidential for the patient and presented within the Urgency medical Profile generated in step 1040 of the process of FIG. 10. A second level of display allows the possibility for the emergency doctor to be aware of the whole set of data by entering the password of the card holder, or alternatively through the trusted third party procedure which was described above.

### 7. Additional Developments and Final Considerations

There will now be described some specific developments:

7.1) the application levels used in the medical card
7.2) how to secure the medical card together with the saving of data
7.3.) The advantages of the embodiments described

### 7.1. Possible Application Levels:

Various application levels could be proposed:

### 7.1.1. Level 1 Application

### Questionnaire:

For the user, a double questionnaire:
a questionnaire dedicated for non confidential data
a questionnaire for protected data
The questionnaires could be filled successively or separately by a login/password generated by the initialization/server
The questionnaire for non confidential data would be automatically displayed as an electronic PDF file type. The Protected questionnaire would be displayed in its original appearance with the login/password (thus allowing to dynamically switch from one questionnaire to the other)

### Attached Files

The questionnaire dedicated for non confidential data would allow the displaying of a limited number of attachments (the identity photography, blood type, vaccinations and allergies if the patient has a medical document confirming serious allergy)
The protected questionnaire would include all attachments corresponding to the requested items.

This card would achieve a basic level of protection.

### Dynamism of the Screens, Customization, Security and Medical Validation.

There would be no dynamic presentation dedicated to the emergency doctor, but a PDF display
With regard to customization, it would be limited to the choice of not answering a question, and would be guided by each of the two questionnaires on the publication of data. A text box would supplement the information for each of the two questionnaires, providing a space for freedom of publication or unlimited privacy
With regard to the security: protection of the card (virus intrusion, destruction/hacking software . . . ), but also a generation of a lost password and, when possible, creation of a new mandatory password in case of a loss of the medical card

### Medical Validation:

Attachments, even in level 1 of the questionnaire which is published without restrictions, already determine a level of medical validation.
Attachments to the protected Questionnaire can be automated adaptation to the storage space.
With regard to this medical validation, it is proposed to display an area of “Medical collaboration”. Such area would then indicate:
If there are attachments or not, the number of attachments, and possibly give direct access to the attachment file, according to the questionnaire being considered.
It indicates whether the file/questionnaire was completed in collaboration or with the help of a professional practitioner. If this is the case, it would be provided the doctor's name, and all reference. If this is not the case, the area would be empty. Historical background of validation is expected.

### 7.1.2. Level 2—Application

high capacity storing support
Single questionnaire, but dynamic over several chapters
Questionnaire allowing direct flagging the data being deemed important and non confidential. Customizing the synthesis.
Dynamic displaying for the emergency doctor of the data which are no longer in PDF format, but in a dynamic mask where each chapter is associated with the important data which may be displayed (printed), and to which the emergency doctor may have an access by directly clicking on the chapter and, by login/password may directly access to the protected information.

This will enable the emergency doctor to directly go to the critical chapters being considered, particularly in case of urgency/lack of time.
On this card, the level of security can be improved, thanks to a more elaborated system for block the card and/or by restitution of a forgotten password.
With regard to the attachments, those would be accessible by direct link, without a classification file.
Compulsory monitoring of the history of the medical validation.

These various embodiments allow the development of successive levels with different objectives in terms of accommodation cost, cost regarding the external support (capacity), but also vis-à-vis the national legislation relating medical data which can be applicable (single declaration or request authorization . . . CNIL).

The spirit of the invention remains the same, giving each level
A suitable and simple medical questionnaire used by the patient to enable him to determine its Personal Medical Profile.
A medical validation by attachments or co-validation certificate issued by a doctor clearly identified.
A dynamic presentation, easy and efficient for emergency services and departments.
The possibility to display data which are deemed non confidential by the patient himself, combined
a password to protect access to sensitive data.
A secure procedure in case of loss or theft of the support.

The advantage of these embodiments is to propose technical solutions that can address separate medical interests:
Level 1: A financially attractive level to buy and no recurrence, “CNIL declarative” but medically validated and protected

Login/password for confidential data.

This level would include a security for loss or theft.

The possibility to delegate to a trusted third party in case of urgency.

This product typically corresponds to the needs of the urgency medical profile
Level 2: A hosted and secure product, allowing recurrence and statistics, with high medical validation (authentication) more suited to a larger medical profile (senior, disability, chronic disease.) and a more elaborated “Exchange” between the doctor and his patient, with differentiated accesses.
Level 3: A product that mixed the first 2 levels, irreproachable from a medical point of view and also with regard to security, allowing traveling over different countries and which allow display of an personal Medical Profile even without any on-line connection. This would correspond to more monitoring of the case by the physician through the patient.

This innovation thus has a solution:

Simple, because the described solution is simple to use for both the patient and the doctor.
Essential because it provides essential or vital information, and with different aims: (people at risk=emergencies, disability, senior, athletes, pregnant women . . . ), not to the entire population unlike Personal Dossier medical.
Personal, in the sense of customizable by the patient himself, which then keeps all the control of its own data to be published, the data which he wishes to have displayed or the data which needs to be protected and even not disclosed.
Secure, both with regard to the technical protections and to the concept of confidentiality which must be respected.
Validated in the sense of medical validation but also validation by the French Authority CNIL (Commission Nationale Informatique et Libertés).

### 7.2. Securing the Card and Data Backup

### 7.2.1. Data Backup.

Given that the data entered by the patient are stored on the card, it may be appropriate to consider a backup process, for example according to one of three procedures below:
the use of a one-time connection to the central server at the patient's request for the purpose of allowing the backup of the data being stored on the card, in particular in a file which is anonymous and encrypted. This backup file can be referenced by a code specific to the patient associated with its own card. Thus, the patient and may at any time to connect to the central server and restore their data in case of loss of the card and the issuance of another card.
The implementation of a local backup, at the patient's request so as to allow him/her to backing his data to another media (PC, tablet etc.) These data will be stored in an anonymous and encrypted file on the chosen support, for example referenced by a code specific to the patient and not linked to its own card. In this way, the patient could return at any time their data in case of loss of the card and the issuance of another.
The implementation of an automatic local backup procedure using a mirror system operating with the patient's personal computer. This system will allow to generate a copy of its data and even the application, which will be stored on his personal computer.

Thus, thanks to the implementation of any of these procedures, the patient may at any time restore their data in case of loss of the card and issuing another. He/she will also use its own PC for inputting data and allow the transmission of anonymous data to the server for the purpose of allowing various statistical calculations.

This solution will also allow a possible dialogue with other software installed on the computer that the patient would be likely to enrich the Medical Profile with medical monitoring elements (radiology, biology, blood pressure monitoring, monitoring the heart rate practice sports, diabetes monitoring . . . )

### 7.2.2—SECURING THE MEDICAL CARD

The goal is to secure the software being hosted on the card.

### 7.2.2.1. Partitioning the USB Stick:

We can consider the following 3 partitions:

### 7.2.2.1.1.—Boot Partition

CD-Rom format, read only, not editable, AutoPlay by the system
containing the boot program.

### 7.2.2.1.2—Program Partition

Format FAT32 or NTFS
Encrypted and hidden,
read-write (for updates).
containing the software and the questionnaire.

### 7.2.2.1.3. Data Partition

FAT32 Format.
Encrypted and hidden.
taking all the remaining space available on the USB key.
Saturated virtual volume (themselves encrypted), maximum 4 GB (up to fill the partition).
the first virtual volume will contain the database
other contain any files attached to the questionnaire by the user (until the saturation all virtual volumes).

### 7.2.2.2) Partitions Opening

7.2.2.2.1. The operating system will open automatically (unless it is disabled in the preferences) the boot partition, boot and run the software (developed by us).
7.2.2.2.2. This boot software will decrypt the program partition (but shall keep it hidden) and run the main program.
7.2.2.2.3 The software, in case where the user has entered his username and password, decrypts the data partition (but keep hidden), as well as the virtual volumes therein contained.
7.2.2.3) Protection against viruses:
The only partition accessible at any time is the boot partition, not editable read-only (thus protected).
The other two partitions are encrypted and hidden.
The other two partitions, and virtual volumes will contain (once decrypted and accessible) files stopping viruses (“autorun.inf” file read-only, “recycled” files and “recycle” masked; . . . )
Saturation of partitions by virtual volumes prevent a virus instead of having to settle on the USB key.

### 7.2.2.4) Protection Against User Errors:

No “standard” access to the application or data; avoiding inadvertent deletion or modification of files manually.
Access only to the boot partition, read-only and contains only the boot software.
All the data and all files attached by the user to the questionnaire are only accessible by the main application.
Profiles, public, confidential, accessible only by the application.

### 7.2.2.5) Protection Against Access to Confidential Data:

Data is stored in an encrypted database; herself in an encrypted and hidden partition.
The generation of the confidential profile is always “on the fly”, only if the user to seized property are username and password, and is never stored.

### 7.2.2.6) Protection Against Theft or Loss:

A malicious person can not access the confidential data only if it knows the username and password of the card owner.
This same person will access only public data card, as default the personal medical staff.
If the person requests a password reset, the corresponding reset code (one per card) will be sent to the owner of the card (email address stored and preserved at the time of activation of the card).

### 7.3. Final Considerations: Significant Advantages

The solutions described above, and particularly the embodiment of the medical card, provide significant advantages, particularly because it is a solution ensuring the centralization and sharing of digital medical data in an environment which conventional shows many obstacles to the development of new improvements.

### 7.3.1. The Obstacles Shown by the Medical Community

The inventors have found that in many cases, medical professionals may find it difficult to adhere to a project of the centralized record of medical information for various reasons: lack of time, double entering of data in software, issues related to the rewarding of an administrative activity which is not medical, fear of “share” the information . . . ).

In general, there is little motivation which is shown by doctors for providing such public interest service, which clearly did not any economic justification, at least for them.

In view of the implementation of a major project of digitization of medical records, it is apparent to the inventors that the initiative could come more easily from the patients.

### 7.3.2. Economic Obstacles

From an economic standpoint, the centralization appears costly in terms of hosting (Approval required for the hosting service providers for medical data hosting).

The interfacing software is long and expensive resulting in on-going new updates for the constantly adapting an interface.

### 7.3.3. Technical Obstacles

From a technical point of view, the difficulty to manage the access rights is extremely complex for the purpose of implementing an exchange between professional practitioners owning to all specialties and all categories (medical, paramedical . . . ).

Securing such a centralization requires a huge amount of resources even though the “inviolability” still remains not guaranteed.

It is still unclear what technological solution (constantly changing) will win the maximum adherence among physicians:
classical computer which now allows the reading of imaging through a DVD/DICOM
tablets or smartphones without any possible connective,
synchronized local applications
or purely web connected softwares in the absence of internet network . . . .

Technological and commercial challenges are still risky.

### 7.3.4. Legal Obstacles

From a legal point of view, finally, the complexity of the national regulations concerning the hosting of medical data, as soon as they are collected by the practitioner, is a major obstacle: need for the patient consent, strong authentication required, exchanges of information over different countries having different levels of protection, completeness of recorded data, confidential access . . . .
Such complexity is at its higher level in France with the concept of authorized hosting which, while introducing extra protection to secure data, considerably increases the hosting costs.

Given all these obstacles and resistance, the inventors have discovered that the solutions recommended and described above, particularly with the embodiment of the personal medical card, are likely to provide a quicker solution to be implemented for emergency situations and priority targets while waiting a maturation of the policy of centralized hosting dedicated to the general public, which maturation might still take several years to complete.

Therefore the medical card that has been described above, in combination with the processes described and claimed, achieves a particularly advantageous solution because:
it significantly involves the Patient (which affects or not confidential information entered into the form, and having a medical validation)
it can avoid to some extent the requirement of a centralized and systematic medical data hosting, since some of them may be stored on the card;
it applies to the essential part of the medical file, but not its entirety (profile instead of the medical File)
it focuses mainly to some sensitive or priority customers;
It is materializable and easily accessed
it is Inexpensive for patients (and without cost to the State)
And, above all, it respects all legislation on the security and confidentiality vis-à-vis the patient.

These are significant advantages that should contribute to a rapid spread of the solutions described above.

1. A method for generating a digital medical file stored on a secure server (50) and accessible from a first system (10) via a data communication network, the digital medical file including both personal data and confidential data, wherein the process further comprises the automatic generation of an Urgency Medical Profile, UMP, devoid of any personal and any confidential information, which can be displayed without the need of any password and which allows an indirect access to the digital medical file comprising personal and medical information through a trusted third party.

2. Process according to claim 1, wherein the Urgency Medical File, UMP, is generated when opening the account holder, following the filling of a predetermined medical questionnaire.

3. Process according to claim 1, wherein the entering of data is associated with the assignment of a confidentiality flag representing the confidentiality of each data entered by the holder of the medical file.

4. Process according to claim 3, wherein said Urgency Medical File, UMP, is stored on a physical media held by the holder, such as a storage card or USB key, allowing unrestricted access to said non-confidential information entered by cardholder.

5. Process according to claim 4, wherein the contents of said physical support is protected by electronic signature so as to guaranty the integrity of the data therein stored.

6. (canceled)

7. Process according to claim 1, further comprising the steps of
creation (101) of an account and generation of an identifier and a password;
creation (102) of an administrative questionnaire comprising administrative personal data;
creation (103) of a medical questionnaire for the purpose of collecting medical data, possibly accompanied by attachments confirming such data;
generation (105) of a summary of the data entered via the medical questionnaire, in relation to a classification tool allowing each data to be associated with a confidentiality flag representing confidentiality of the information or not;
designation (106) of one or more trusted third parties;
automatic generation of an Urgency Medical Profile, UMP, which only comprises non nominative data and data deemed to be non confidential, said Urgency Medical Profile being stored in an unprotected area and may be access from an external support comprising said identifier, the other nominative data and/or confidential data being stored within a protected area of said secured server and may be accessed through identifier and password checking procedure;
said Urgency Medical Profile further comprising a link allowing an access to a trusted third party so as to obtain a substitution key or any other technical means which may be used in the absence of the password for the purpose of reading the medical file as well as the confidential data and/or the nominative data therein included.

8. Process according to claim 7, wherein said substitution key results from an express of will of said trusted third party so as to allow an access to the medical file, which takes the form of an electronic message, such as a SMS or an email, or a vocal call, or an electronic message transmitted by an application on the said trusted third party's system.

9. (canceled)

10. (canceled)

11. (canceled)

12. (canceled)

13. Process according to claim 7, wherein the nominative data and/or the confidential data can be accessed from the knowledge of the identifier assigned to the account holder together with the substitution key, and further to the authentication of the system requesting access to the personal data and/or the medical data, said authentication step resulting in a determination that the system requesting access to the medical file belongs to an emergency service or department.

14. Process for accessing a digital medical file stored on a secure server (50) and which can be accessed from a first system (10) via a data communication network, said digital medical file comprising personal data and confidential data, said process further comprising:
the displaying of an Urgency Medical Profile, UMP, which is devoid of any personal data or confidential data, and which allows an indirect access to the digital medical file comprising confidential data and/or personal data via a login/password procedure or via a trusted third party;
the access to said digital medical file via one or more trusted third party.

15. Process according to claim 14, wherein it further comprises:
access (200) to said secure server (50) by means of a physical support comprising an identifier at the exclusion of any password;
presentation of the identifier and opening (201) of a session with said secure server (50);
testing the password (202) and, in the case where a valid password is submitted, opening of the medical file;
in the case where no valid password is presented, optionally transmitting an email to the account holder (203);
displaying (204) an Urgency Medical Profile, UMP,
identifying a trusted third party (205);
accessing said trusted third party and retrieval of a substitution key (206);
transmitting said substitution key (207) to said secure server;
testing (208) said substitution key and, if said substitution key matches one substitution key listed within said medical file, opening said medical file.

16. Process according to claim 14, wherein the access to said digital medical file results from the receipt by said secure server of an electronic mail transmitted by the own system owned by said trusted third party, or still a SMS or an email or a message transmitted by an application being installed on the own system of said trusted third party or a vocal message received from said trusted third party.

17. (canceled)

18. (canceled)

19. Process according to claim 14, wherein the access to said secure server by a memory card or a USB card causes, if the testing of said password is unsuccessful, the transmission of an electronic message to the trusted third party(ies) previously designated by said holder of said memory card.

20. Process according to claim 14, wherein said message transmitted to the trusted third party is an email or a SMS type message, allowing the trusted third party to respond and authorize the opening of said medical file stored on said secure server and, consequently, to allow the access to the personal and confidential data therein stored.

21. Process according to claim 14, wherein it further comprises:
plugging and reading (701) of a non nominative card comprising an Urgency Medical Profile, UMP, which comprises no personal information and no confidential information, as well as a link to accede to said server and to one ore more trusted third parties;
displaying (702) of said Urgency Medical Profile (UMP) on an information processing system of said emergency service;
accessing (703) said secure server (50);
testing the password (704) and if the password if found valid, opening said medical file;
if the password is found invalid, testing (705) the authentication of the system requesting the access to the medical file, and determining whether said system belongs to an emergency service;
identifying (706) one trusted third party;
transmitting a message to said trusted third party (707) for the purpose of obtaining a substitution key;
obtaining (708) said substitution key and retrieving one identification information of said trusted third party;
using (708, 709) of said information for acceding to a protected area of said remote server.

22. Process for generating a digital medical file to be stored on a removable support, such as a storage card, comprising a storage memory and a computer program stored on said support, said process further involving the steps:
transmitting (1010) a request dedicated to an external server so as to obtain a key or an activation code for said computer program, said request allowing a subscription before said server;
receiving (1020) said key or said activation code generated by said server;
starting (1030) said computer program so that the patient may enter data within a medical Questionnaire adapted for collecting personal and medical data, and the storage of said data within a database located within said removable support, each data being entered by said patient being associated with a flag representative of the confidential nature or not of said data being entered within said questionnaire;
generating (1040) automatically a Urgency Medical Profile, UMP, corresponding to the patient, for instance in an electronic format which may be displayed in various languages, and which only comprises data having a flag representative of a non confidential nature.

23. Process according to claim 22, wherein the access to the nominative and confidential data included in said medical file may performed through a trusted third party.

24. (canceled)

25. Process according to claim 22, wherein it involves the steps of:
creating (101) an account and generating an identifier with a password;
creating (102) an administrative questionnaire comprising personal administrative information;
creating (103) a medical questionnaire dedicated to collect medical information, possibly accompanied by attachments confirming said information;
generating (105) a summary of the data entered through said medical questionnaire, in relation with a classification tool serving for flagging each individual data with a confidential character or not;
designating (106) one or more trusted third parties;
generating automatically an Urgency Medical Profile, UMP, which only comprises non nominative data and data not deemed to be confidential, said Urgency Medical data being stored in a non protected area and may be accessed from an external support comprising said identifier, the other nominative data and/or confidential data being stored in a protected area of said secure server which may be accessed through said identifier and said password;
wherein said Urgency Medical Profile further comprises a link for acceding a trusted third party for the purpose of obtaining a substitution key which may be used without the need of any password or any technical means allowing the opening of the medical file, including the personal and/or confidential data.

26. Process according to claim 25, wherein the substitution key results from an express of will of said trusted third party for allowing the access to the medical file, or may take the form of an electronic message, such as a SMS or an email, or a vocal call, or an electronic message transmitted by an application on the Trusted third party's system.

27. Electronic storage support for storing a digital medical file comprising a storage area for said digital medical file, and a computer program stored on said support, adapted for the execution of the process of claim 22, said support further comprising:
means for transmitting a request dedicated to an external server for the purpose of obtaining a key or an activation code of said computer program, said request allowing an administration subscription before said server;
means for receiving the key or said activation code generated by said server;
means for starting said computer program so that the patient may enter data within a medical Questionnaire adapted to collect personal and medical data, and the storage of the latter within a database which is located on said storage support, each data being entered being further flagged as being confidential or not;
means for automatically generating an Urgency Medical Profile, UMP, corresponding to the patient, for instance in an electronic format which may be displayed in various languages, and which only comprises data being flagged as being non confidential.

28. Support according to claim 27, wherein it further comprises means for allowing an indirect access through a trusted third party to the digital medical file including nominative and/or confidential information.

29. (canceled)

30. (canceled)

31. (canceled)
